(19) United States
(12) Patent Application Publication
(10) Pub. No.: US 2001/0041009 A1
(43) Pub. Date: Nov. 15, 2001

(54) Customer information management system and method using text recognition technology for the indentification card

(75) Inventor: Sung Jin Lee, Gyeonggi-do (KR)

Correspondence Address: SHANKS & HERBERT, Intellectual Property, TransPotomac Plaza, 1033 N. Fairfax Street, Suite 306, Alexandria, VA, 22314, US

(73) Assignee: Stelcom Corp.

(21) Appl. No.: 09/852,323

(22) Filed: May 10, 2001

(30) Foreign Application Priority Data
May 10, 2000 (KR) 2000-24887

(51) Int. Cl. G06K 9/68

(52) U.S. Cl. 382/218

(57) ABSTRACT

The present invention relates to managing various client information and provides a system and method for managing customer information such as name, identification number/code, address, and picture effectively. More particularly, the present invention relates to a customer information management system that enables to promptly and exactly complete a procedure of retrieval and registration of customer information by automatically inputting customer name, national registration number, address, and picture simultaneously using an optical device such as camera and text recognition technology, and a customer information management method using the system.

### BACKGROUND OF THE INVENTION

1. Technical Field

The present invention relates to a system for managing customer information, and more particularly, to an apparatus and method for automatically inputting customer information and storing it in a database.

2. Background Art

Conventional automatic identity verification systems include an apparatus reading contact/non-contact IC cards and/or cards with a magnetic strip and a barcode reader. But these conventional verification systems and method have drawbacks of being able to use only one predetermined type of identification cards. Each ID card issuer has to develop its own reading apparatus.

### SUMMARY OF THE INVENTION

It is an objective of the present invention to efficiently store and manage data about customers, by using a character recognition technology. The objective is achieved by providing an apparatus that can read and recognize a variety of standard identification cards, i.e., government issued Ids such as residence cards or driver's license, saving companies a need to issue their own customer identification cards and associated costs. It is another objective of the present invention to automatically store the pictures in the Ids as well as normal identification data such as names, address and unique ID numbers. The inventive apparatus is mainly comprised of preferably digital cameras, a computer running a character recognition software application and a database.

### BRIEF DESCRIPTIONS OF THE DRAWINGS

The above and other objects and features of the present invention will become apparent from the following description of preferred embodiments given in conjunction with the accompanying drawings, in which:

FIG. 1 is a perspective view of an embodiment of the present invention.

FIG. 2 is a block diagram of the present invention.

FIG. 3 is a flowchart illustrating reading and discriminating information of identification cards.

FIG. 4 illustrates multiple cameras placed at an angle to read information underneath a hologram of an ID card according to the present invention.

FIG. 5 is a flow chart illustrating a learning process of discriminating information according to the present invention.

### DETAILED DESCRIPTION OF THE PRESENT INVENTION

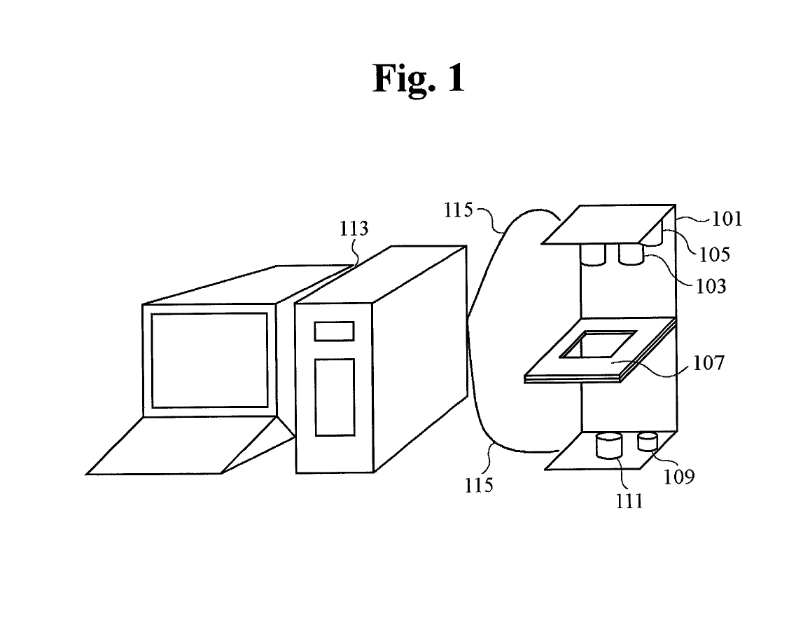

FIG. 1 illustrates a customer information management system according to the present invention. The system is comprised mainly of a picture input apparatus and a computer 113. The picture input apparatus includes one or more of front cameras 103, rear cameras 111. The front camera takes a picture of the front side of an identification card and the rear, which is optional, takes a picture of the back side of the card. The cameras are connected to the computer via a high speed communication cable such as Universal Serial Bus (USB) so that the picture data taken by the cameras are transmitted to the computer at a high data rate. Light fixtures 105, 109 may be provided next to the cameras when the ambient light is not bright enough for picture taking. Between the two cameras is a positioner 107 that would hold identification cards. It has an aperture that can accommodate different shapes of ID cards. The cameras are preferably digital ones using charge coupled devices (CCD) for example. Any commercially known digital cameras will do. The computer is provided with one or more of software applications that allow recognition of characters from a digital image and management of collected customer information among other things.

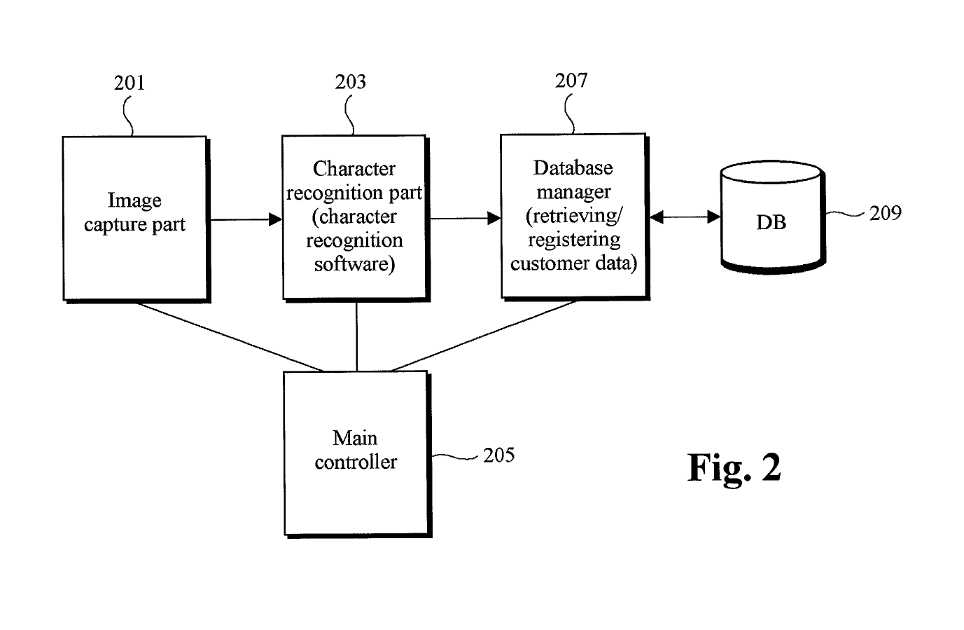

FIG. 2 is a functional block diagram of the present invention. The image capture block 201, under the control of the main controller 205 digitally reads the image of an ID card. Digital images would preferably have a resolution of 640 by 480 or 1024 by 768 pixels. Other resolutions may be used depending on the size of alphanumeric characters in a card. The digital image is transmitted to the character recognition block 203. The character recognition block performs a preliminary process and discriminates the type of the ID by recognizing basic characters before performing a full scale character recognition. Thus recognized characters are transmitted to the database manager 207 to see if there is prestored information about the ID holder. If no information was stored about the ID holder the current data obtained from reading the ID is stored as the information of the ID holder. Otherwise, the prestored information in the database about the card holder is displayed. A name or unique identification number commonly written on the ID is used as the keyword to search the database, which could store more detailed information about customers.

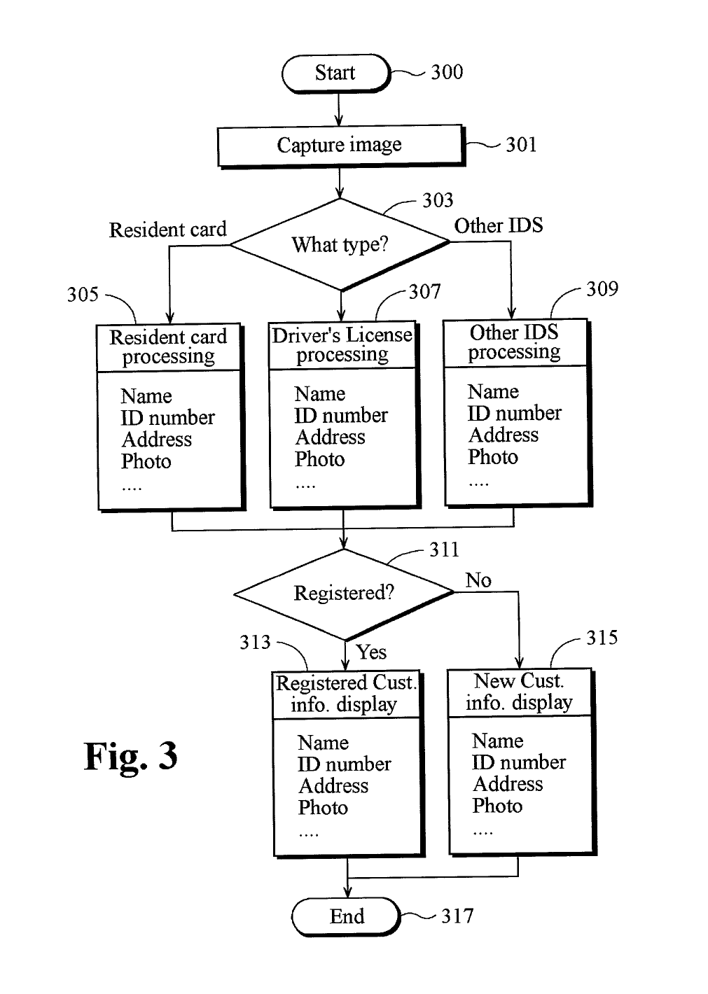

FIG. 3 is a flow chart for processing customer information. First, the image of an ID, taken by cameras, is transmitted to a computer (step 301). The computer discriminates the type of the card by looking at the top of the card image (step 303), where a card type is commonly indicated. Once a card type is determined, the computer knows where to look for names, ID number, address, etc. because the officially issued cards have them in same predetermined areas. For instance, if the ID is determined to be a resident card (step 305), the resident number may be read from a designated area in the card. If it was a driver's license (step 307), relevant driver information such class of vehicles permitted to operate could easily found by looking at its designated place. The information of other types of ID cards can be read in the same manner (step 309). Here any known character recognition methods or algorithm may be used. Since the fonts of characters used in identification cards would be known, almost error-free character recognition is possible. Let's take nationally standardized resident identification cards, for example, that have predefined six major sections on the front for the header, names in the Korean alphabet, names in the Chinese alphabet, identification number, address, issue authority in addition to the photo. Thus the computer would know where to look for an address when the card is determined to be a resident ID. Other fields of information are similarly read in. In this way a variety of identification cards can be read as long as their information organizations were recorded in the computer beforehand.

After the ID card information is read, one field of information, e.g., name or identification number, is used as an index to see if the ID holder's information is already in the database (step 311). If so, the stored information about the ID holder is displayed (step 313). Otherwise, new customer registration is performed using all or part of the fields of information that have been recognized (step 315).

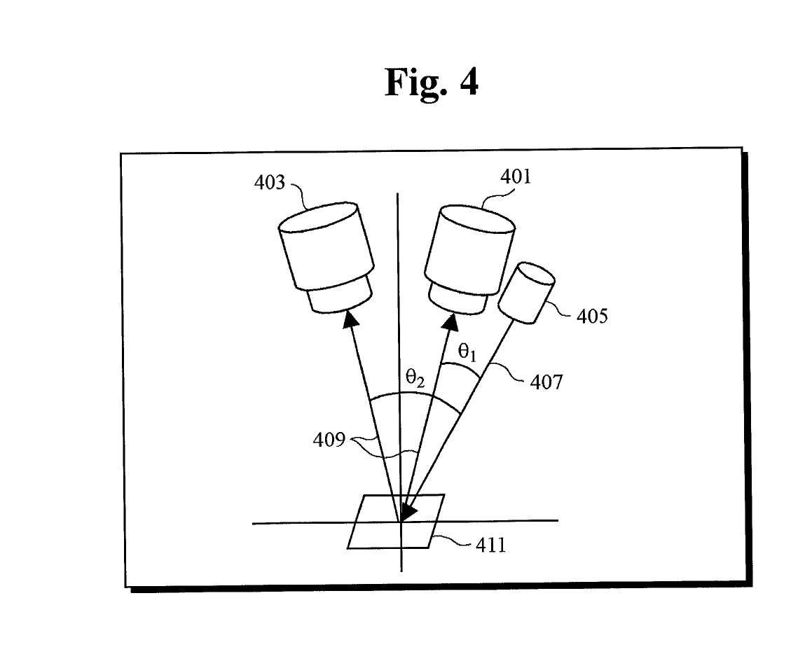

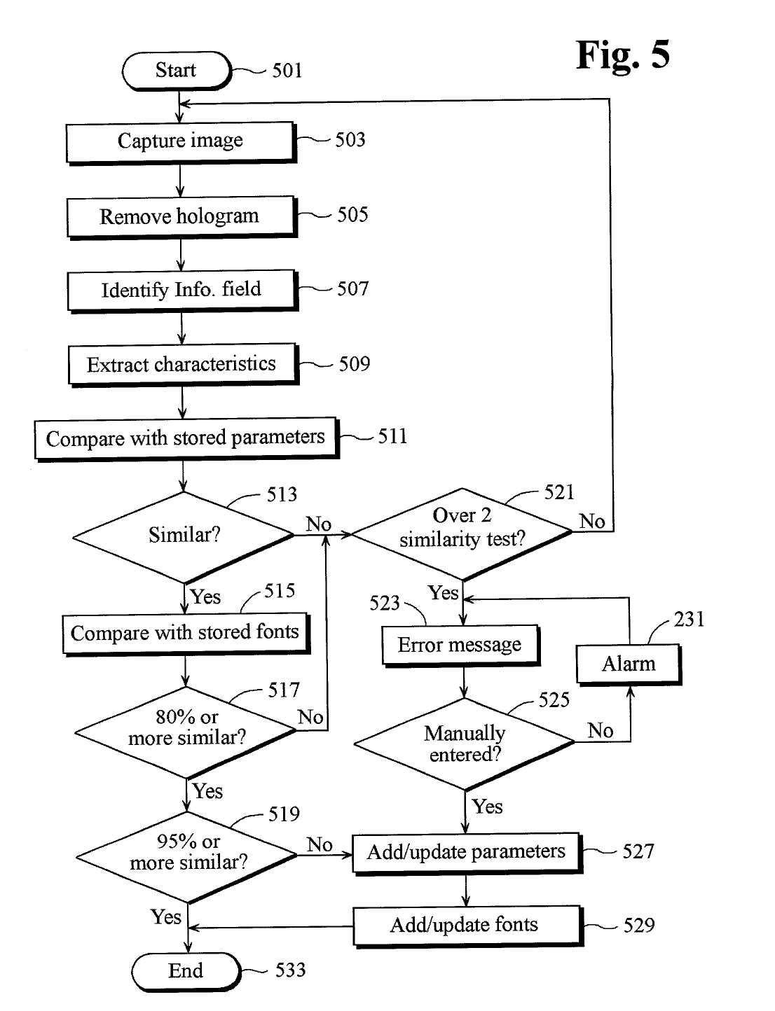

Some cards have a hologram printed over one or more fields of ID information to prevent an unscrupulous reproduction of cards. But the presence of a hologram makes it difficult to discern characters underneath. According to one aspect of the present invention, bright color bands that appear on the captured digital image due to a hologram are removed in order to allow the information the hologram overlapped to be read. As shown in FIG. 4, at least two cameras 401, 403 at different shooting angles 01, 02 each take the image of a hologram ID. By producing a composite of the images the interfering color bands can be removed. Specifically, light reflected off a subject, i.e., an ID card, reaches a plurality of cameras placed at an angle with respect to the plane 411 of the subject. It is known that a different image of a hologram appears if seen from a different angle. Thus the images taken by the cameras placed at an angle with respect to the plane of the subject would have different hologram images. The different digital images are compared with each other pixel by pixel. And out of two counterpart pixels, the one with lower luminance is selected to be the pixel of the composite image because the characters in ID cards are normally printed in black on a white or light color background. Characters that are comprised of thus selected pixels are discriminated using the aforementioned character recognition software application. According to one aspect of the present invention, the character recognition software learns characters it encounters for the first time and thus does not recognize, by prompting the human user to type in the characters and stored them in the database. The computer can be programmed to repeat the picture taking from the start. Only when repeated reading fails the learning process may kick in. For example, in case that a letter is recognized from a supposedly-all numerical ID number field, the picture of the ID could be taken again or an error message could be displayed on a display device to prompt the human user to enter the correct data. This learning process will be described in details in reference to FIG. 5.

When a digital image of an ID is inputted (step 503), a hologram, if any, is removed (step 505) by the above-described method before each field/area of information of the ID is identified (step 507). The characteristics of an alphanumeric element of each identified field/area in the digital image are extracted (step 509) before compared with parameters prestored in the database (511). If found similar (step 513), the font of the element is further compared with stored fonts to ascertain the similarity (step 515). In case that the similarity is over a predetermined degree of confidence the alphanumeric element is determined to be that corresponding the parameters used in comparison. Here the test of similarity can be a two-step process (steps 517 and 519), where, only when it exceeds a first and “coarse” confidence level, it is tested against to a more rigorous threshold. The confidence threshold can be adjusted by the user. For instance, the coarse threshold could be 85% confidence while the second and final threshold is set at 95%. If the characteristics of the alphanumeric element are not similar to parameters prestored in the database, the reading algorithm starts all over again provided that the similarity test was performed only once. If a similarity test with the stored parameters fails again, then an error message calling for the operator's attention is generated periodically until he/she manually inputs the card information (steps 523, 525,231). After the manual entry, the parameters and font of the element are either updated or recorded in the database (step 527). In addition, those alphanumeric elements that passed the first confidence test but failed the second are be considered as having new parameters and fonts and their parameters and fonts are similarly stored in the database as part of the learning process.

The present invention has been so far described for an embodiment that takes the image of the front of an ID. According to another aspect to the present invention, the backside information of a card, usually update/change of one or more fields of the information on the front of the card, is also detected using the same image capture and the character recognition software described above. If this updated information was handwritten, the human operator is prompted to manually input the backside information as the current customer information, with which the computer replaces corresponding stored information.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A system for managing customer information, comprising:
a camera device for taking an image of an identification card;
a computer device for processing the image and managing the processed image data as customer information; and
an interface device for transmitting the image data from the camera device to the computer device, so that the interface device is connected between the camera device and the computer device.

2. The system of claim 1, wherein the computer device receives the image data and extracts customer information, and retrieves or registers automatically corresponding customer data using extracted information.

3. The system of claim 1, wherein the camera device inputs a front and a rear image of the identification card simultaneously, and wherein the system receives the image data inputted to the computer device and uses information of the rear image of the identification card as new customer information and processes information of the front image of the identification card as old information.

4. The system of claim 3, wherein the camera device includes:
at least two cameras for canceling a hologram attached on the identification card, so that the cameras are installed to have a predetermined angle;
a supporting means for exactly positioning the identification card so as to exactly recognize customer information; and
illuminating means for providing necessary light so as to input the image of the identification card.

5. A method of managing customer information, comprising steps of:
inputting image data of an identification card;
transmitting the image data to a computer device; and
processing customer information by processing the image data.

6. The method of claims 5, wherein the step of processing customer information further comprises steps of:
extracting information from the identification card; and
retrieving or registering automatically customer information by using extracted information.

7. A system for managing customer information, comprising:
a camera device for taking an image of an identification card;
a means for determining a type of said identification card,
a means for reading information from predetermined areas of said image according to said type,
a means for discriminating said information and
a database capable of storing and providing information associated with said identification card.

8. The system of claim 7, further comprising a means for retrieving information from said database, based on the discriminated information.

9. The system of claim 7, further comprising a means for registering said discriminated information in said database.

10. The system of claim 7, wherein the camera device captures a front and a rear images of said identification card simultaneously, and said discriminating means further includes a means for using information of said rear image as valid information.

11. The system of claim 3, wherein the camera device includes:
at least two cameras disposed at an angle with respect to said identification card for capturing images of said identification card from different angles;
a means for comparing information from a predetermined area of one of said two images to information from said predetermined area of the other of said two images and a means for selecting one of said two images for discrimination of said information of said predetermined area.

12. A method of managing customer information, comprising steps of:
taking an image of an identification card;
determining a type of said identification card,
reading information from predetermined areas of said image according to said type, discriminating said information and
storing to or providing from a database formation associated with said identification card.

13. The method of claims 12, further comprising the step of
retrieving, from a database, prestored information associated with said information of said identification card if one piece of said card information is determined to be existent in said database;
storing said card information in said data base if none of said card information is determined to be existent in said database.

14. The method of claims 12, further comprising the steps of:
capturing images of said identification card from different angles;
comparing information from a predetermined area of one of said two images to information from said predetermined area of the other of said two images; and
selecting one of said two images for discrimination of said information of said predetermined area.
